(19) United States
(12) Patent Application Publication
(10) Pub. No.: US 2021/0288586 A1
(43) Pub. Date: Sep. 16, 2021

(54) POWER CONTROLLERS

(71) Applicant: HEWLETT-PACKARD DEVELOPMENT COMPANY, L.P., Spring, TX (US)

(72) Inventors: Xavier Soler Pedemonte, Sant Cugat del Valles (ES); Albert Trenchs Magana, Sant Cugat del Valles (ES); Luis Angel Ortega Estornel, Sant Cugat del Valles (ES)

(21) Appl. No.: 16/608,358

(22) PCT Filed: Jan. 24, 2018
(86) PCT No.: PCT/US2018/015002

§ 371 Date: Oct. 25, 2019

(51) Int. Cl. H02M 5/458; H02M 7/219; H02M 1/00; H02M 1/12; H02M 1/42

(52) U.S. Cl. CPC H02M 5/4585; H02M 7/219; H02M 1/4233; H02M 1/12; H02M 1/0009

(57) ABSTRACT

Example implementations relate to an apparatus to control supplying power to a linear load; the power having a predetermined current profile; the apparatus comprising a controller to establish synchronisation information associated with an AC input voltage of an AC supply; and produce at least one pulse width modulation signal in response to the synchronisation information and a target instantaneous current of the predetermined current profile; and at least one output to output the at least one pulse width modulation signal to a current modulator for controlling current to the linear load.

Non-linear loads can cause undesirable harmonics, in terms of current harmonics and voltage harmonics, that can distort the power factor of power supplied from a power source such as, for example, the utility system, grid or other power distribution system. Standards have been established that set limits associated with harmonics that have the potential to interfere with, or otherwise adversely affect, power supplied by such a power source. Examples of such standards are, for example, IEC61000-3-2, EN61000-3-2 and IEEE519-1992.

An AC to DC converter can convert an AC supply to a DC supply. Such converters can present a non-linear load to the AC supply with the concomitant risk of creating such harmonics.

### BRIEF DESCRIPTION OF THE DRAWINGS

Various implementations are described, by way of example, referring to the accompanying drawings, in which:

FIG. 1 shows a power controller according to example implementations;

FIG. 2 depicts a further power controller according to example implementations;

FIG. 3 illustrates a view of current modulation using pulse width modulation according to example implementations;

FIG. 4 shows a further view of current modulation using pulse width modulation according to example implementations;

FIG. 5 shows a schematic current profile according to example implementations;

FIG. 6 illustrates a current profile according to example implementations;

FIG. 7 shows peak current control with constant off time according to example implementations;

FIG. 8 depicts a multi-phase power controller according to example implementations;

FIG. 9 illustrates a current profile for a 3-phase supply according to example implementations; and

FIG. 10 illustrates a flow chart according to example implementations

### DETAILED DESCRIPTION

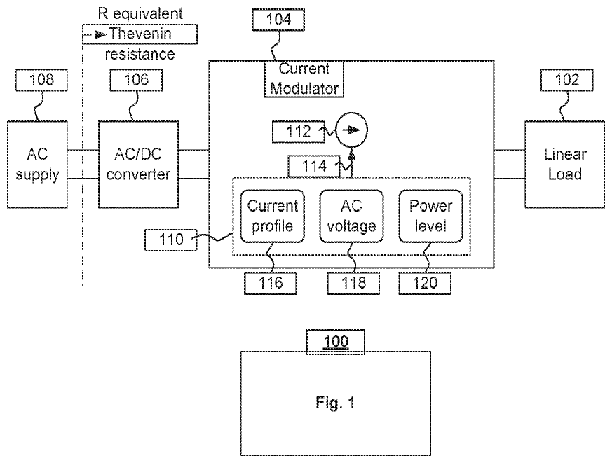

Referring to FIG. 1, there is shown a view of an apparatus 100 for influencing controlling the power to a load 102. The load 102 is a linear load such as, for example, a resistive load. A resistor, or resistance, is an example of a linear load. The apparatus 100 comprises a current modulator 104 for supplying current to the load 102. The current modulator 104 can be coupled to a DC source such as, for example, an AC/DC converter 106 that converts AC power from an AC power supply 108 to DC. The DC source can comprise a rectifier such as, for example, a diode bridge rectifier. The diode bridge rectifier can be a full-wave bridge rectifier.

The current modulator 104 comprises a controller 110 and a current source 112. Example implementations can be realised in which the controller 110 comprises a suitably programmed microcontroller, other processor and software. The current supplied by the current source 112 can be varied in response to one or more than one control signal 114. The controller 110 is arranged to vary the current supplied by the current source 112, via the control signals 114, in response to one or more than one parameter. Example implementations can vary the current supplied by the current source 112 in response to at least one or more than one of a predetermined or predeterminable current profile 116, one or more than one characteristic of the AC supply voltage 118 and a desired power level 120 to the load 102.

The predetermined or predeterminable current profile can be realised as look-up table comprising current levels calculated in advance or the current levels can be calculated as needed. Example implementations can be realised in which the current profile 116 is arranged reflect a current associated with the current that would be supplied by the AC supply to a perfectly linear load or a purely resistive load. Such a current supplied by the AC supply to a perfectly linear load or a purely resistive load would be free of harmonics. Example implementations, therefore, control the current supplied to the load 102, and, therefore, the current drawn from the AC supply, assuming a single-phase supply, according to the following formula:

$$Iout = \frac{P}{Vout} = \frac{\hat{V} sin ω t}{R} , 0 \leq ω t \leq π ,$$

where Iout is the instantaneous current through the inductor of the current profile at time t, \hat{V} is a peak voltage supplied by the AC supply, R is the equivalent Thevenin resistance seen by the AC supply, and ω is the angular frequency of the AC voltage. Alternatively, assuming a three-phase supply, the current supplied to the load 102, and, therefore, drawn from the AC supply, is determined according to the formula:

$$Iout = \frac{Pout}{Vout} = \frac{\hat{V}}{2 \sqrt{3} R} \frac{1}{1 - {\sum }_{k = 1}^{∞} \frac{2}{36 {k}^{2} - 1} cos 6 ω t} ,$$

0≤ωt≤π/3, where Iout is the instantaneous current through the inductor of the current profile at time t, \hat{V} is a peak voltage supplied by the AC supply, R is the equivalent Thevenin resistance seen by the AC supply and ω is the angular frequency of the AC input voltage.

The one or more than one characteristic of the AC supply 118 comprises synchronisation information to allow the current supplied by the current modulator 104 to be synchronised with the AC voltage supply. Such synchronisation can lead to a favourable power factor. Example implementations can be realised in which the power factor is unity or within a predetermined tolerance such as, for example, 3%, 10% or some other tolerance. The synchronisation information can comprise at least one, or both, of the phase or timing of the AC supply and the frequency, ω, of the AC supply, or at least one, or both, of the phase of the rectified output from the converter 106 or the frequency of the rectified output from the converter 106.

The power level 120 of the power supplied to the load 102 can be controlled according to P′out=I′ₒᵤₜ²R′ where P′out is the power supplied to the load 102, I′ₒᵤₜ is the output current controlled according to the current profile, and R′ is the resistance of the linear load.

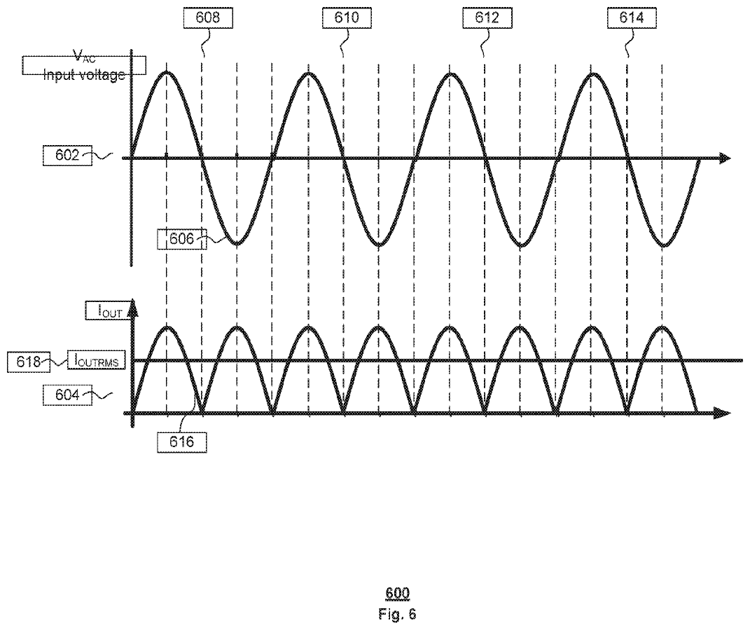

For a single-phase supply, the output current shape will be synchronised with the AC input voltage. The frequency will be 100 Hz, for an AC supply frequency of 50 Hz, or 120 Hz, for an AC supply frequency of 60 Hz. Example implementations can be realised in which the output current profile has sinewave shape. The sinewave shape can be a rectified sinewave shape such as that described later with reference to FIG. 6. The unrectified sinewave can be described by, or derived or otherwise calculated from, the following

P_{AC}=[\hat{V} sin ωt]/R,

V_{OUT}=sin ωt for 0≥ωt≤π

$${I}_{OUT} = \frac{{P}_{OUT}}{{V}_{OUT}} = \hat{V} sin ω t / R$$

where P_{OUT} is the power of the AC supply 108, \hat{V} is the peak voltage of the AC supply, ω is the angular frequency of the AC supply, t is time, and I_{OUT} is the inductor or AC supply current. The rectified sinewave can be described by the above

$${I}_{OUT} = \vert \frac{{P}_{OUT}}{{V}_{OUT}} \vert = \vert \hat{V} sin ω t / R \vert for 0 \leq ω t \leq π$$

Having the above sinewave rectified current, the RMS voltage at the load side will be such at Vrms_{OUT}≤Vrms_{IN}.

The current profile 116 for a three-phase AC supply can be calculated, or otherwise determined from, the following:

P_{IN}=P_{AC1}+P_{AC2}+P_{AC3}

$${P}_{AC 1} = {[ \hat{V} sin ω t ]}^{2} / R$$

$${P}_{AC 2} = {[ \hat{V} sin ( ω t - \frac{2 π}{3} ) ]}^{2} / R$$

$${P}_{AC 3} = {[ \hat{V} sin ( ω t - \frac{4 π}{3} ) ]}^{2} / R$$

Therefore,

$${P}_{IN} = {P}_{AC 1} + {P}_{AC 2} + {P}_{AC 3} = \frac{{[ \hat{V} sin ω t ]}^{2}}{R} + \frac{{[ \hat{V} sin ( ω t - \frac{2 π}{3} ) ]}^{2}}{R} + \frac{{[ \hat{V} sin ( ω t - \frac{4 π}{3} ) ]}^{2}}{R} = \frac{3 \hat{V}}{2 R}$$

$${V}_{OUT} = \frac{3 \sqrt{3} \hat{V}}{π} [ 1 - {\sum }_{k = 1}^{∞} \frac{2}{36 {k}^{2} - 1} cos 6 k ω t ] ,$$

which gives a current profile of

$${I}_{OUT} = \frac{{P}_{OUT}}{{V}_{OUT}} = \frac{\hat{V} π}{2 \sqrt{3} R} \frac{1}{1 - {\sum }_{k = 1}^{∞} \frac{2}{36 {k}^{2} - 1} cos 6 k ω t} , 0 \leq ω t \leq π / 3$$

Having the above sinewave rectified current, the RMS voltage at the load side will be such at Vrms_{OUT}≅2.34 Vrms_{IN}.

Again; the output current, I_{OUT}, through the inductor, or drawn from the AC supply, will be synchronised with the AC input voltage; which provides a power factor of unity, or at least a power factor having a predetermined tolerance such as, for example, 3%, 10% or some other tolerance.

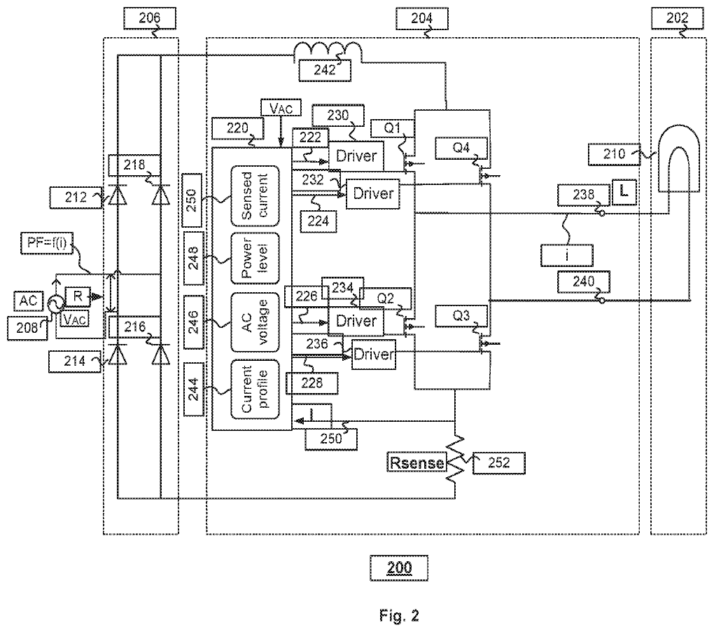

Referring to FIG. 2, there is shown a view of a further power or current controller 200 according to example implementations. The controller 200 can be coupled to a linear load 202. The linear load 202 can be a resistor or resistance load. The controller 200 comprises a current modulator 204 for coupling to the load 202 and a DC source 206. The DC source 206 can produce DC power or at least a DC voltage from an AC supply 208.

In any of the example implementations herein, the linear or resistive load can be an infrared (IR) lamp 210. The DC source 206 can comprise a rectifier such as, for example, a full-wave rectifier. In the illustrated example, the full-wave rectifier comprises a number of diodes 212 to 218 forming a bridge rectifier. The rectifier supplies a rectified voltage to the current modulator 204.

The current modulator 204 comprises a controller 220. The controller 220 is operable to produce several control signals 222 to 228 for controlling respective switches Q1 to Q4. The control signals 222 to 228 can be coupled to the respective switches Q1 to Q4 via respective drivers 230 to 236. The switches can be transistors such as, for example, FETs. The switches Q1 to Q4 are arranged in an H-bridge. The H-bridge comprise a pair of outputs 238, 240 for coupling to the load 202 such as the IR lamp 210. The current modulator 204 comprises an inductor 242 for supplying current to the H-bridge. An inductor is an example of a current source. The inductor 242 can be coupled to the rectifier 206 to couple current from the AC supply 208 to the IR lamp according to the state of the control signals 222 to 228 supplied to the switches Q1 to Q4. Inductors are example of current sources.

The controller 220 is responsive to a number of parameters to control the current to the load 102. The parameters comprise a predetermined or predeterminable current profile 244, synchronisation information 246 associated with the AC supply, a desired power level 248 and an instantaneous sensed current, I_{OUT}, 250 through the inductor or drawn from the AC supply, taken jointly and severally in any and all permutations, that have all been described above with reference to FIG. 1. The instantaneous sensed current 250 can be sensed using a resistor 252 through which the inductor current flows, which will give a respective voltage that can be detected by the controller 220.

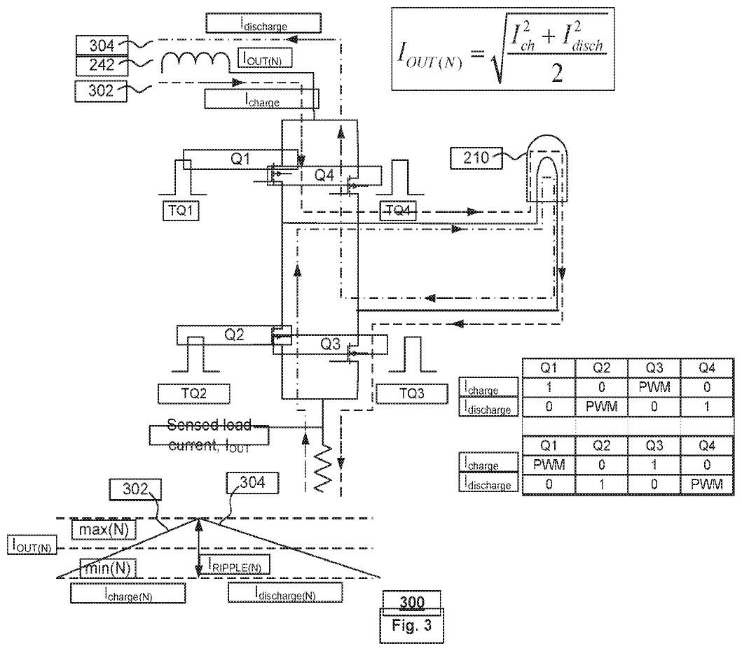

Referring to FIG. 3, there is shown a simplified view 300 of the operation of example implementations. The operation will be described with reference to the controller 204 shown in and described with reference to FIG. 2. The FETs Q1 to Q4 are operated in pairs, FETs Q1 and Q3 are switched on and off together in anti-phase with FETs Q2 and Q4 that are also switched on and off together. While FETs Q1 and Q3 are on, and FETs Q2 and Q4 are off, a charging current 302 flows through Q1, the load, which is the IR lamp 210 in this example, and Q3. The charging current 302 can be sensed via a corresponding voltage drop across the sensing resistor 252, The current 302 through the inductor 242 rises for a period determined by the pulse width of the control signals applied to Q1 and Q3.

During a subsequent period, FETs Q2 and Q4 are switched on and FETs 01 and Q3 are switched off, a discharging current 304 flows in the opposite direction to the charging current 302. The discharging current 304 flows through FET Q2, the load 210, FET Q4 and inductor 242, Again, the discharging current can be detected via the voltage drop across sensing resistor 252. The current 304 through the inductor falls for a period of time determined by the pulse width of the control signals applied to FETS Q2 and Q4.

The durations of such a rise and fall in currents 302, 304 gives an average target current, I_{OUT}. The rise and fall of the currents 302, 304 can result in a current ripple 306. The current ripple 306 can be varied by varying the frequency of the pulses of the control signals. Increasing the frequency of the pulses of the control signals reduces the current ripple 306. The target current for any given time period will be determined from the current profile for that time period. The height of the charging current 302 will be determined by the duration of the on pulse for FETs Q1 and Q3. The depth of the discharge current 304 will be determined by the duration of the on pulse for FETs Q2 and Q4.

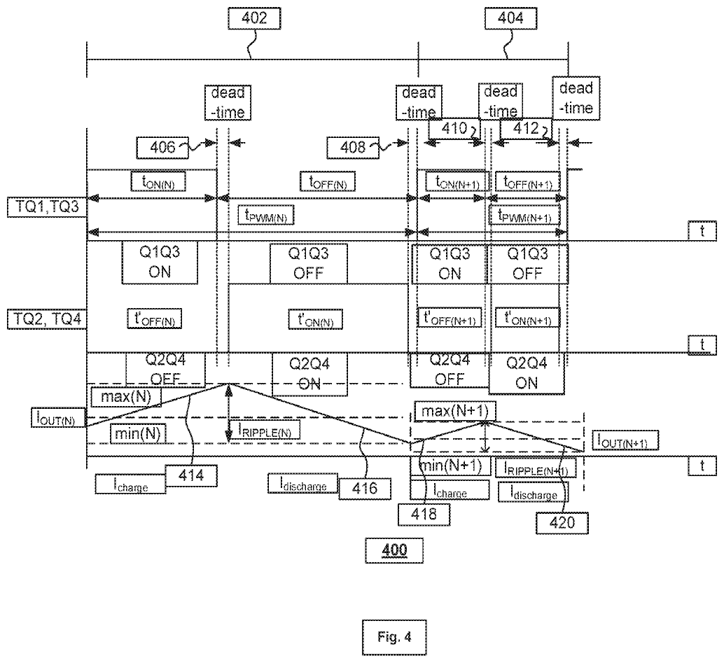

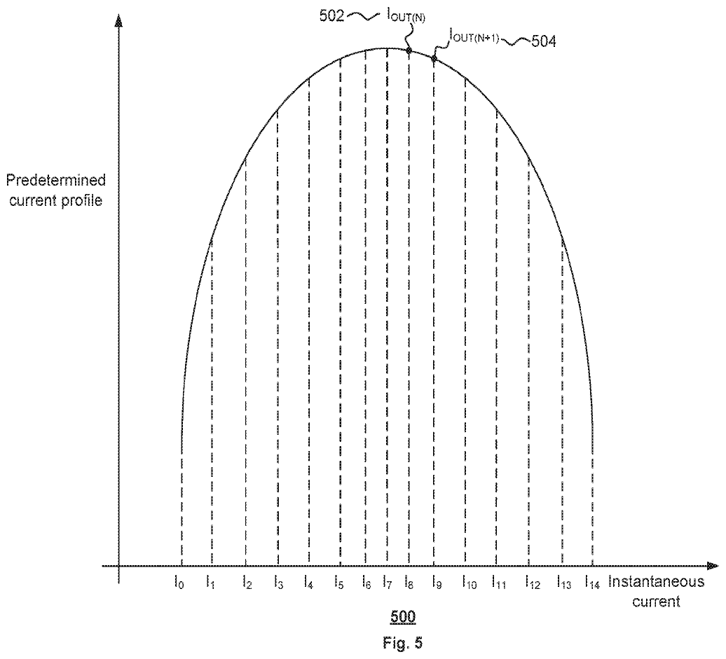

Referring to FIGS. 4 and 5, there is shown a view 400 of the operation a controller for establishing consecutive different inductor/AC supply currents I_{OUT(N)} and I_{OUT(N+1)} according to a predetermined current 500 profile shown in FIG. 5. The predetermined current profile 500 comprises a number of target inductor currents I₁, to I₁₄ corresponding to respective time periods. The predetermined current profile 500 has been illustrated using 15 target output currents. However, the number 15 has been chosen as an illustrative example. Example implementations can use many more target output load current levels to increase the resolution of the current and more closely reflect or follow a desired current profile. Two currents I_{OUT(N)} 502 and I_{OUT(N+1)} 504 have been selected to be generated in consecutive time periods (N) 402 and (N+1) 404.

During the first time period (N) 402, the first current I_{OUT(N)} 502 is generated by the control signals TQ1 and TQ3 switching on their respective switches Q1 and Q3 for a respective duration t_{ON(N)} and control signals TQ2 and TQ4 switching off their respective switches Q2 and Q4 for a respective duration t′_{OFF(N)}. Then control signals TQ2 and TQ4 switch on their respective switches Q2 and Q4 for a respective duration t′_{ON(N)} while control signals TQ1 and TQ3 switch off their respective switches Q1 and Q3 for a respective duration t_{OFF(N)}.

It will be appreciated that there are dead-times or guard times 406 to 412 between the control signals for Q1 and Q3 and the control signals for Q2 and Q4. The dead-times or guard times ensure that Q1 and Q2 are not simultaneously switched on and that Q3 and Q4 are not simultaneously switched on. It can be appreciated that the charging current 414 increases for the period of time that Q1 and Q3 are switched on. Similarly, the discharging current 416 decreases for the period of time that Q2 and Q4 are switched on.

During the second time period (N+1) 404, the second current I_{OUT(N+1)} 504 is generated by the control signals TQ1 and TQ3 switching on their respective switches Q1 and Q3 for a respective duration t_{ON(N+1)} and control signals TQ2 and TQ4 switching off their respective switches Q2 and Q4 for a respective duration t′_{OFF(N+1)}. Then control signals TQ2 and TQ4 switch on their respective switches Q2 and Q4 for a respective duration t′_{ON(N+1)} while control signals TQ1 and TQ3 switch off their respective switches Q1 and Q3 for a respective duration t_{OFF(N)}. It can be appreciated that the charging current 418 increases for the period of time that Q1 and Q3 are switched on. Similarly, the discharging current 420 decreases for the period of time that Q2 and Q4 are switched on.

Since the target current I_{OUT(N+1)} is lower than the preceding current I_{OUT(N)}, the discharging duration t′_{ON(N)} is longer than the charging duration t_{ON(N)} so that the current reaches a lower level than the current level at the beginning of the preceding time internal 402. Also, the charging duration t_{ON(N+1)} of the subsequent time interval 402 is shorter than the charging duration t_{ON(N)} of the preceding time interval 404 since the target current I_{OUT(N+1)} is intended to be lower than the preceding target current I_{OUT(N)}. The converse to the foregoing would apply if the predetermined or predeterminable current profile 500 called for the target current I_{OUT(N+1)} being higher than the preceding target current I_{OUT(N)}.

Referring to FIG. 6, there is shown a view 600 of a pair of graphs 602 and 604. A first graph 602 of the pair of graphs depicts the variation of the AC supply voltage 606 with time over four cycles 608 to 614.

A second graph 604 of the pair of graphs depicts the variation of the predetermined or predeterminable current profile 616 with time over the four cycles 608 to 614. The current profile 616 is an example of the above described current profiles.

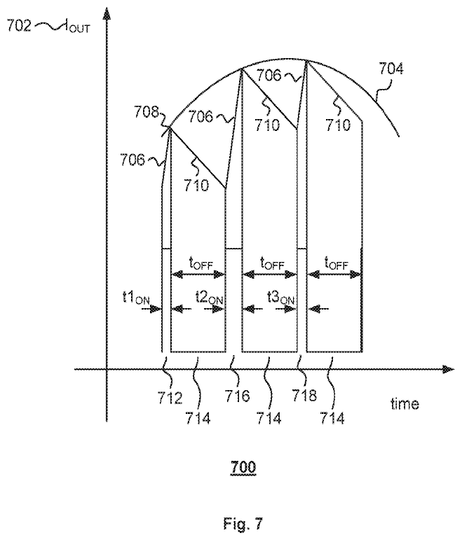

FIG. 7 shows a view 700 of waveforms associated with a further example implementation of a current modulator such as, for example, the above current modulator 204 described with reference to, and as shown in, FIG. 2. The controller 220 of the current modulator 204 can be configured to use peak current control with PWM and a constant off time. It can be appreciated that the inductor 242 is connected to a voltage source, which is provided by the rectifier 206. The controller 220 is arranged configure the switches Q1 to Q4 to allow an inductor current, or output load current to flow in a charging direction, which causes the inductor current, or output load current to rise. The controller 220 is configured to compare the level of the inductor, or output load current, with a desired instantaneous current level of an associated current profile. Once the inductor current, or output load current, reaches the desired instantaneous level, the switches Q1 to Q4 are configured to allow the inductor current to flow in the discharging direction, which will cause the inductor current, or output load current to fall. Example implementations are arranged to provide a fixed discharge or off time. It can be appreciated that the foregoing is realised using pulse width modulation in which the duty cycle is variable, and set by the desired instantaneous output current while the off time is constant. The frequency of the pulse width modulation signal is higher than the frequency or variation of the current profile.

FIG. 7 depicts a graph 702 of a current profile 704 governing the load current to be output to the load or through the inductor. It can be appreciated that the inductor current, or output load current, 706 is allowed to rise by switching on Q1 and Q3, as previously described with reference to FIG. 2. The controller 220 is configured compare the instantaneous load current, via the sensing resistor 252, with the current profile, or an instantaneous target current 708 of the current profile 704. When the output load current reaches the level of the current profile, the controller 220 is configured to switch off Q1 and Q3 for a constant period of time, while switching on Q2 and Q4 to allow the inductor current 710, output load current, to discharge, that is, to flow in the opposite direction for a constant period of time. It will be appreciated that the combination of the rising output current and the current profile leads to a respective pulse width 712 for the control signals to the switches Q1 to Q4; with Q1 and Q3 operating in anti-phase with Q2 and Q4, with appropriate dead-times or guard times therebetween. The discharging current 710 is allowed to flow by the controller for a fixed period of time, t_{OFF}, 714. During the fixed periods 714, Q2 and Q4 are controlled by the controller to be on, and Q1 and Q3 are controlled by the controller to be off. The foregoing is repeated at a high frequency, relative to the frequency of the current profile, so that the resulting sawtooth waveform follows the current profile. While fixed periods 714 have the same duration, the various pulse widths 712, 716, 718 have respective durations governed by the rise time of the inductor current and the current profile. Therefore, the charging times, t1_{ON}, t2_{ON}, t3_{ON}, are variable according to the current profile, whereas the discharging times t_{OFF} are fixed.

It will be noted that the example implementations do not have, and do not need, a filter or capacitor across the output of the rectifier, which results in a cost saving and lower manufacturing complexity.

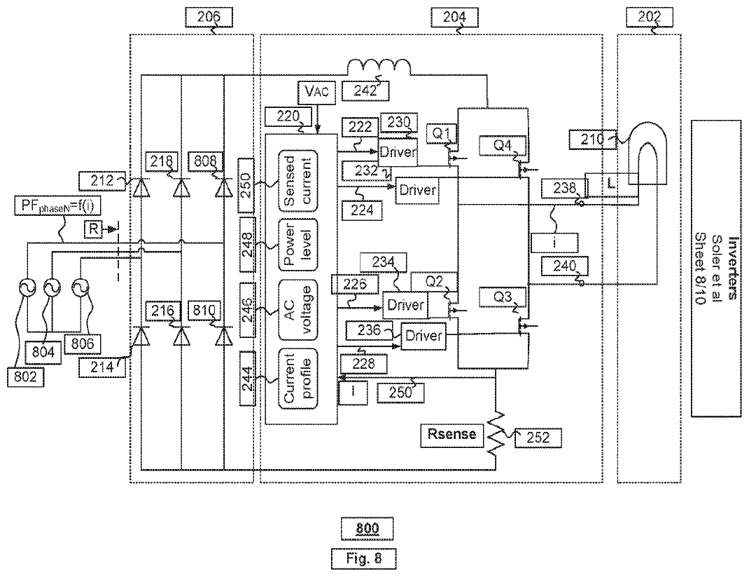

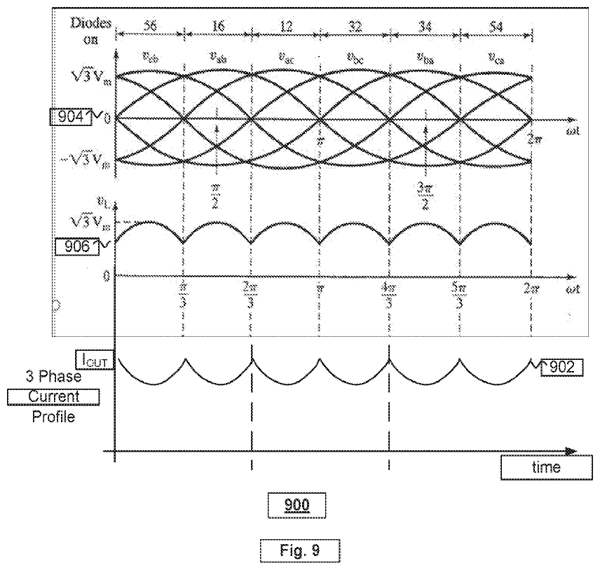

Referring to FIG. 8, there is shown a view 800 of a current modulator for controlling the output or load current according to a predetermined or predeterminable current profile that is identical in operation to the above described examples, in particular, the example described with reference to FIGS. 2 and 7, but with a different predetermined or predeterminable current profile, which is depicted in, and described with reference to, FIG. 9, a different, 3-phase, AC supply and a correspondingly different rectifier. The same reference numerals refer to the same elements and have the same operation or function. The AC supply comprises three phases 802 to 806 that are separated by 120 degrees. The rectifier 206 comprises a pair of diodes per phase. Therefore, in addition to diodes 212 to 218, an additional pair of diodes 808 and 810 are provided.

Referring to FIG. 9, there is shown a graph 900 of the current profile 902 for the 3-phase example implementation described with reference to, and as illustrated in, FIG. 8. The inductor current profile 902 can be described mathematically by

$${I}_{OUT} = \frac{{P}_{OUT}}{{V}_{OUT}} = \frac{\hat{V} π}{2 \sqrt{3} R} \frac{1}{1 - {\sum }_{k = 1}^{∞} \frac{2}{36 {k}^{2} - 1} cos 6 k ω t} , 0 \leq ω t \leq π / 3$$

as indicated above.

FIG. 9 also a first graph 904 that shows the three voltage waveforms of the AC supply separated by 120 degrees and a second graph 906 that shows the voltage waveform output by the 3-phase rectifier 206. The current profile 902 is synchronised with, that is, has the same phase and frequency as, the voltage waveform 906 output by the rectifier. Example implementations can be realised in which the current profile is the same as that described above with reference to FIG. 8.

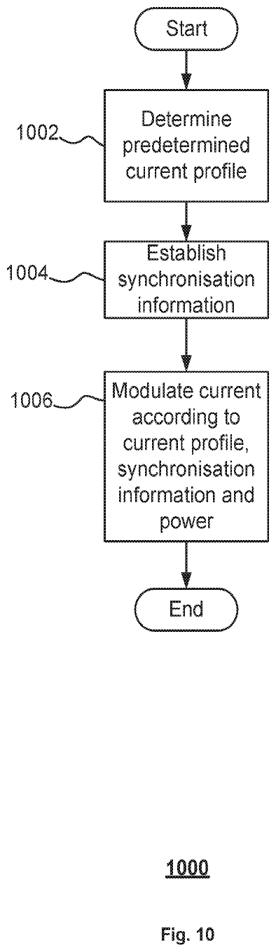

Referring to FIG. 10, there is shown a flow chart 1000 of operations performed by the current modulators of the example implementations. At 1002, a desired current profile is determined or accessed. At 1004, synchronisation information associated with the AC supply is determined so that the output current can be in phase with, and have an appropriate frequency relative to, the AC supply. At 1006, the current modulator is operated to realise appropriate pulse widths and timings in response to at least one of the current profile, the synchronisation information, or the instantaneous load current taken jointly and severally in any and all permutations.

The foregoing example implementations can be realised in a printing device, in particular, in a 3D printing device to control the IR lamp or lamps within such a printing device.

Example implementations of the present disclosure can be realised in the form of, or using, hardware, software or a combination of hardware and software. The hardware can comprise one, or both, of a processor and electronics. The foregoing, that is, the hardware, software or a combination of hardware and software, are implementations of circuitry. The circuitry can be configured or arranged to perform a respective purpose such as, for example, implementing any or all of the example implementations described in this specification. Any such software may be stored, in the form of executable code, on volatile or non-volatile storage such as, for example, a storage device like a ROM, whether erasable or rewritable or not, or in the form of memory such as, for example, RAM, memory chips, device or integrated circuits or machine-readable storage such as, for example, DVD, memory stick or solid-state medium. Storage devices and storage media are example implementations of machine-readable storage or non-transitory machine-readable storage that are suitable for storing a program or programs, that is, machine executable code, comprising instructions arranged, when executed, to realise example implementations described and claimed herein. Accordingly, example implementations provide machine executable code for realising an apparatus, a system, device, method or for orchestrating or controlling a method, developer, system or device operation as described in this specification or as claimed in this specification and machine-readable storage storing such code. Still further, such programs or code may be conveyed electronically via any medium such as a communication signal carried over a wired or wireless connection and example implementations suitably encompass the same.

Example implementations can provide a printer or printing device operable according to any of the methods described or shown in this specification.

Any or all of the methods described or claimed in this specification can be used to control a printing device comprising an IR lamp to be powered by the example implementations. Therefore, example implementations provide a controller to implement the methods described in this specification.

Example implementations described and claimed in this specification can result in at least one, or both, of an improvement in power factor or harmonics such as, for example, as experienced by the AC supply.

Example implementations can be realised according to the following clauses:

Clause 1: An apparatus to control supplying power to a linear load; the power having a predetermined current profile; the apparatus comprising a controller to establish synchronisation information associated with an AC input voltage of an AC supply, and produce at least one pulse width modulation signal in response to the synchronisation information and a target instantaneous current of the predetermined current profile; and at least one output to output the at least one pulse width modulation signal to a current modulator for controlling current to the linear load.

Clause 2: The apparatus of clause 1; further comprising a rectifier to produce a rectified voltage signal from the AC input voltage.

Clause 3: The apparatus of any preceding clause, further comprising: the current modulator to modulate, in response to the at least one pulse width modulation; an instantaneous current of a current source output via modulator outputs for coupling the instantaneous current to the linear load.

Clause 4: The apparatus of clause 1, further comprising a rectifier to produce a rectified voltage signal from the AC input voltage; a current modulator to modulate, in response to the at least one pulse width modulation, an instantaneous current of a current source output via modulator outputs for coupling the instantaneous current to the linear load; and an inductor disposed between the rectifier and the current modulator.

Clause 5: The apparatus of any preceding clause, in which the controller to establish synchronisation information from the AC input voltage comprises circuitry to derive phase and frequency information associated with the AC input voltage.

Clause 6: The apparatus of clause 5, in which the circuitry to derive phase and frequency information associated with the AC input voltage comprises circuitry to derive said phase and frequency information from the AC input voltage or from a rectified voltage signal.

Clause 7: The apparatus of any preceding clause, in which the rectifier comprises a diode bridge.

Clause 8: The apparatus of any preceding clause, in which the current modulator comprises one or more than one switch, responsive to the at least one pulse width modulation signal, to modulate the instantaneous current of the current source.

Clause 9: The apparatus of any preceding clause in which the current modulator comprises a plurality of switches, responsive to the at least one pulse width modulation signal, to modulate the instantaneous current of the current source.

Clause 10: The apparatus of any preceding clause in which the current modulator comprises a number of switches arranged in an H-bridge, responsive to the at least one pulse width modulation signal, to modulate the instantaneous current of the current source.

Clause 11: The apparatus of any preceding clause in which the predetermined current profile comprises a plurality of instantaneous currents scalable by the controller in response to at least one of the synchronisation information or a desired output power to be supplied to the linear load.

Clause 12: The apparatus of any preceding clause in which the predetermined current profile is associated with at least one of

$$Iout = \frac{P}{Vout} - \frac{\hat{V} sin ω t}{R} ,$$

where Iout is the target instantaneous current of the current profile at time t, \hat{V} is a peak voltage of the AC supply, R is the equivalent Thevenin resistance seen by the AC supply, and ω is the angular frequency of the AC voltage, or

$$Iout = \frac{Pout}{Vout} = \frac{\hat{V}}{2 \sqrt{3} R} \frac{1}{1 - {\sum }_{k = 1}^{∞} \frac{2}{36 {k}^{2} - 1} cos 6 k ω t} , 0 \leq ω t \leq π / 3 ,$$

where Iout is the target instantaneous current of the current profile at time t, \hat{V} is a peak voltage of the AC supply, R is the equivalent Thevenin resistance seen by the AC supply, and ω is the angular frequency of the AC supply.

Clause 13: The apparatus of any preceding clause in which the predetermined current profile comprises a look-up table having a plurality of instantaneous currents scalable by the controller in response to at least one of the synchronisation information or a desired output power to be supplied to the linear load.

Clause 14: The apparatus of clause 11 in which the predetermined current profile is calculated from at least one of

$$Iout = \frac{P}{Vout} - \frac{\hat{V} sin ω t}{R} ,$$

where Iout is the target instantaneous current of the current profile at time t, \hat{V} is a peak voltage of the AC supply, R is the equivalent Thevenin resistance seen by the AC supply, and ω is the angular frequency of the AC voltage, or

$$Iout = \frac{Pout}{Vout} = \frac{\hat{V}}{2 \sqrt{3} R} \frac{1}{1 - {\sum }_{k = 1}^{∞} \frac{2}{36 {k}^{2} - 1} cos 6 k ω t} ,$$

0≤ωt≤π/3, where Iout is the target instantaneous current of the current profile at time t, \hat{V} is a peak voltage of the AC supply, R is the equivalent Thevenin resistance seen by the AC supply, and ω is the angular frequency of the AC supply.

Clause 15: The apparatus of any preceding clause in which the instantaneous current is an RMS current.

Clause 16: The apparatus of any preceding clause in which the current source is an inductor.

Clause 17: An apparatus to control output load current to a linear load according to a predetermined load current profile; the apparatus comprising a controller to control a plurality of switching devices, arranged in an H-bridge, via respective control signals; at least two of the control signals comprising pulse width modulation signals having duty cycles associated with respective instantaneous output load currents derived from the predetermined load current profile and a given inductance; the pulse width modulation signals having respective frequencies and phases derived from an AC input voltage.

Clause 18: The apparatus of clause 17 in which the output load current is an RMS output load current averaged over a cycle of the pulse width modulation signals.

Clause 19: A method to control supplying power to a linear load; the power having a predetermined current profile; the method comprising establishing synchronisation information associated with an AC input voltage; producing at least one pulse width modulation signal in response to the synchronisation information and a target instantaneous current of the predetermined current profile; and outputting the at least one pulse width modulation signal to a current modulator for controlling current to the linear load.

Clause 20: The method of clause 19, further comprising producing a rectified voltage signal from the AC input voltage.

Clause 21: The method of any of clauses 19 to 21, further comprising: modulating, in response to the at least one pulse width modulation, an instantaneous current of a current source output via modulator outputs for coupling the instantaneous current to the linear load.

Clause 22: The method of clause 19, further comprising producing a rectified voltage signal from the AC input voltage; modulating, in response to the at least one pulse width modulation, an instantaneous current of a current source output via modulator outputs for coupling the instantaneous current to the linear load.

Clause 23: The method of any of clauses 19 to 22, in which establishing synchronisation information from the AC input voltage comprises deriving phase and frequency information associated with the AC input voltage.

Clause 24: The method of clause 23, in which deriving phase and frequency information associated with the AC input voltage comprises deriving said phase and frequency information from the AC input voltage or from a rectified voltage signal of the AC input signal.

Clause 25: The method of any of clauses 19 to 24, comprising switching one or more than one switch of the current modulator in response to the at least one pulse width modulation signal to modulate the instantaneous current of the current source.

Clause 26: The method of any of clauses 19 to 25 comprising switching a plurality of switches of the current modulator in response to the at least one pulse width modulation signal to modulate the instantaneous current of the current source.

Clause 27: The method of any of clauses 19 to 26, in which the predetermined current profile comprises a plurality of instantaneous currents scalable by the controller in response to at least one of the synchronisation information or a desired output power to be supplied to the linear load.

Clause 28: The method of any of clauses 19 to 27 in which the predetermined current profile is associated with at least one of

$$Iout = \frac{P}{Vout} - \frac{\hat{V} sin ω t}{R} ,$$

where Iout is the target instantaneous current of the current profile at time t, \hat{V} is a peak voltage of the AC supply, R is the equivalent Thevenin resistance seen by the AC supply, and ω is the angular frequency of the AC supply, or

$$Iout = \frac{Pout}{Vout} = \frac{\hat{V}}{2 \sqrt{3} R} \frac{1}{1 - {\sum }_{k = 1}^{∞} \frac{2}{36 {k}^{2} - 1} cos 6 k ω t} ,$$

0≤ωt≤π/3, where

Iout is the target instantaneous current of the current profile at time t, \hat{V} is a peak voltage of the AC supply, R is the equivalent Thevenin resistance seen by the AC supply, and ω is the angular frequency of the AC supply.

Clause 29: The method of any of clauses 19 to 28 in which the predetermined current profile comprises a look-up table having a plurality of instantaneous currents scalable by the controller in response to at least one of the synchronisation information or a desired output power to be supplied to the linear load.

Clause 30: The method of clause 29 in which the predetermined current profile is calculated from at least one of

$$Iout = \frac{P}{Vout} - \frac{\hat{V} sin ω t}{R} ,$$

where Iout is the target instantaneous current of the current profile at time t, \hat{V} is a peak voltage of the AC supply, R is the equivalent Thevenin resistance seen by the AC supply, and ω is the angular frequency of the AC supply, or

$$Iout = \frac{Pout}{Vout} = \frac{\hat{V}}{2 \sqrt{3} R} \frac{1}{1 - {\sum }_{k = 1}^{∞} \frac{2}{36 {k}^{2} - 1} cos 6 k ω t} ,$$

0≤ωt≤π/3, where Iout is the target instantaneous current of the current profile at time t, \vec{V} is a peak voltage of the AC supply, R is the equivalent Thevenin seen by the AC supply, and ω is the angular frequency of the AC supply.

Clause 31: Machine executable instructions arranged, when executed by a processor, to implement a method of any of clauses 19 to 30.

Clause 32: Machine readable storage storing machine executable instructions of clause 31.

1. An apparatus to control supplying power to a linear load; the power having a predetermined current profile; the apparatus comprising
a. a controller to
i. establish synchronisation information associated with an AC input voltage of an AC supply; and
ii, produce at least one pulse width modulation signal in response to the synchronisation information and a target instantaneous current of the predetermined current profile; and
iii. at least one output to output the at least one pulse width modulation signal to a current modulator for controlling current to the linear load.

2. The apparatus of claim 1, further comprising
a. a rectifier to produce a rectified voltage signal from the AC input voltage.

3. The apparatus of claim 1, further comprising:
a. the current modulator to modulate, in response to the at least one pulse width modulation, an instantaneous current of a current source output via modulator outputs for coupling the instantaneous current to the linear load.

4. The apparatus of claim 1, further comprising
a. a rectifier to produce a rectified voltage signal from the AC input voltage;
b. a current modulator to modulate, in response to the at least one pulse width modulation, an instantaneous current of a current source output via modulator outputs for coupling the instantaneous current to the linear load; and
c. an inductor disposed between the rectifier and the current modulator.

5. The apparatus of claim 1, in which the controller to establish synchronisation information from the AC input voltage comprises circuitry to derive phase and frequency information associated with the AC input voltage.

6. The apparatus of claim 5, in which the circuitry to derive phase and frequency information associated with the AC input voltage comprises circuitry to derive said phase and frequency information from the AC input voltage or from a rectified voltage signal.

7. The apparatus of claim 2, in which the rectifier comprises a diode bridge.

8. The apparatus of claim 1, in which the current modulator comprises one or more than one switch, responsive to the at least one pulse width modulation signal, to modulate the instantaneous current of the current source.

9. The apparatus of claim 1, in which the current modulator comprises a plurality of switches, responsive to the at least one pulse width modulation signal, to modulate the instantaneous current of the current source.

10. The apparatus of claim 1, in which the current modulator comprises a number of switches arranged in an H-bridge, responsive to the at least one pulse width modulation signal, to modulate the instantaneous current of the current source.

11. The apparatus of claim 1, in which the predetermined current profile comprises a plurality of instantaneous currents scalable by the controller in response to at least one of the synchronisation information or a desired output power to be supplied to the linear load.

12. The apparatus of claim 1, in which the predetermined current profile is associated with at least one of
a.
$$Iout = \frac{P}{Vout} - \frac{\hat{V} sin ω t}{R} ,$$
where Iout is the target instantaneous current of the current profile at time t, \hat{V} is a peak voltage of the AC supply, R is the equivalent Thevenin resistance see by the AC supply, and ω is the angular frequency of the AC supply, or
b.
$$Iout = \frac{Pout}{Vout} = \frac{\hat{V}}{2 \sqrt{3} R} \frac{1}{1 - {\sum }_{k = 1}^{∞} \frac{2}{36 {k}^{2} - 1} cos 6 k ω t} ,$$
where Iout is the target instantaneous current of the current profile at time t, V̅ is a peak voltage of the AC supply, R is the equivalent Thevenin resistance seen by the AC supply, and ω is the angular frequency of the AC supply.

13. The apparatus of claim 1, in which the predetermined current profile comprises a look-up table having a plurality of instantaneous currents scalable by the controller in response to at least one of the synchronisation information or a desired output power to be supplied to the linear load.

14. Machine-executable instructions arranged, when executed by a processor, to control supplying power to a linear load; the power having a predetermined current profile; the instructions comprising instructions to establish synchronisation information associated with an AC input voltage; instructions to produce at least one pulse width modulation signal in response to the synchronisation information and a target instantaneous current of the predetermined current profile; and instructions to output the at least one pulse width modulation signal to a current modulator for controlling current to the linear load.

15. Machine readable storage storing machine-executable instructions of claim 14.
